(19) United States
(12) Patent Application Publication
(10) Pub. No.: US 2024/0112150 A1
(43) Pub. Date: Apr. 4, 2024

(54) SYSTEMS AND METHODS TO FACILITATE DECISION MAKING FOR UTILITY NETWORKS

(71) Applicant: CASE WESTERN RESERVE UNIVERSITY, Cleveland, OH (US)

(72) Inventors: Xiong Yu, Beachwood, OH (US); Xudong Fan, Cleveland, OH (US)

(21) Appl. No.: 18/468,009

(22) Filed: Sep. 15, 2023

Related U.S. Application Data
(60) Provisional application No. 63/375,728, filed on Sep. 15, 2022.

(51) Int. Cl. G06Q 10/20; G06Q 10/0631; G06Q 10/0637; G06Q 50/06

(52) U.S. Cl. CPC G06Q 10/20; G06Q 10/06315; G06Q 10/06375; G06Q 50/06

(57) ABSTRACT

Systems and methods are described for making repair decisions to improve resilience of a utility distribution network (UDN). A graph convolutional network (GCN) integrates reinforcement learning to provide an integrated model framework, in which the GCN encodes the information of the UDN, such as topology and operating characteristics. A neural network is connected to the GCN, and the framework trains the neural network to provide a recovery sequence based on the current state (e.g., a damaged state) of the UDN based one or more performance indicators.

### RELATED APPLICATION

This application claims priority from U.S. Provisional Application No. 63/375,728, filed Sep. 15, 2022, the subject matter of which is incorporated herein by reference in its entirety.

### GOVERNMENT FUNDING

This invention was made with government support under 1638320 awarded by the National Science Foundation. The government has certain rights in the invention.

### TECHNICAL FIELD

This application relates to systems and methods to facilitate decision making for utility networks.

### BACKGROUND

Water distribution networks (WDNs) are critical infrastructure for communities. The dramatic expansion of the WDNs associated with urbanization makes them more vulnerable to high-consequence hazards such as earthquakes, which requires strategies to ensure their resilience. The resilience of a WDN is related to its ability to recover its service after disastrous events. Sound decisions on the repair sequence play a crucial role to ensure a resilient WDN recovery.

### SUMMARY

This application relates to systems and methods to facilitate decision making for utility networks.

One example relates to a system to facilitate repair decisions for a utility distribution network (UDN). One or more non-transitory computer-readable memory is programmed to store data and instructions. The data includes UDN model data representative of a structure of the UDN having a plurality of nodes and parameter data characterizing features and connectivity associated with each node of the UDN structure. One or more processors are configured to access the memory and execute the instructions to provide a reinforcement learning framework. The framework includes a graph convolutional neural network (GCN) programmed to encode the structure of the UDN, in which the GCN is programmed to project nodes of the UDN structure into a multi-dimensional state space according to the UDN model data and the parameter data and to provide GCN output data responsive to an input representative of at least a current state of the UDN and one or more actions. A neural network, connected to the GCN, includes an input layer and an output layer. The input layer is programmed to receive the GCN output, and the output layer is programmed to provide a sequence of recovery actions based on a current state space of the UDN model data. A performance calculator is programmed to determine a measurement of the performance of the UDN in response to each of a plurality of recovery actions applied to the UDN model data for a current state space of the UDN over time. The measurement of performance for each recovery action is applied to train the neural network, and the framework is programmed provide a trained GCN-integrated reinforcement learning model that is programmed to generate recovery output data representing a sequence of recovery actions for the UDN in response to input UDN state data representative of a current state of the UDN.

Another example relates to a computer-implemented method to facilitate recovery decisions for a water distribution network (WDN). The method includes storing, in one or more non-transitory machine-readable media, WDN model data representative of the WDN and having a plurality of nodes and parameter data characterizing features associated with respective nodes of the WDN. The method also includes using a graph convolutional neural network (GCN) to encode the structure of the WDN and the parameter data, and provide GCN output data responsive to an input representative of at least a current state of the WDN. The method also includes receiving by a neural network the GCN output. The method also includes providing, by the neural network, a sequence of recovery actions based on a current state space of the WDN model data and a measure of performance. The method also includes computing the measure of performance of the WDN in response to each of a plurality of recovery actions applied to the WDN model data based on the WDN model data for a current state space and over time. The method also includes applying the measurement of performance for each recovery action to train the neural network. The method also includes repeating the training to provide a trained GCN-integrated reinforcement learning model, in which the trained GCN-integrated reinforcement learning model is programmed to generate output data representing a sequence of recovery actions for the WDN in response to input WDN state data representative of a current state of the WDN.

### BRIEF DESCRIPTION OF THE DRAWINGS

FIG. 1 is a graph illustrating an example of WDN system performance prior, during, and after disruption by hazards.

FIG. 2 illustrates an example framework of the system resilience assessment and recovery.

FIG. 3 illustrates parameters k₁ and k_{c} that consider the effects of pipe material, soil electrical electric conductivity, and pipe age.

FIG. 4 illustrates an example of Q-Learning.

FIG. 5 is a conceptual diagram showing DRL that uses Artificial Neural Network (ANN) as the deep Q function.

FIG. 6 illustrates an example architecture of GCN-DRL Hybrid ML model.

FIG. 7 illustrates an example with annotation of node importance and ground soil types.

FIGS. 8A-8B illustrate distribution of PGV along pipelines and number of leakage points alongside the damaged pipes.

FIG. 9 is a graph showing an example learning curve of proposed methods.

FIG. 10 is a conceptual diagram showing crossover.

FIG. 11 is a graph showing the trajectories of WDN recovery using repair sequences by different decision methods.

FIGS. 12A and 12B illustrate examples of initial PGV values and water pipe damage distributions.

FIG. 13 is a graph showing SRI values by different decision methods under different earthquake scenarios.

FIGS. 14A, 14B and 14C illustrate examples of failure situations as a subset of original failure pipes.

FIG. 15 is a block diagram of a system to facilitate repair and/or recovery decisions for a utility distribution network.

### DETAILED DESCRIPTION

This description introduces the development of a Graph Convolutional Neural Network integrated Deep Reinforcement Learning (GCN-DRL) model to support optimal repair decisions to improve resilience of a utility distribution network (UDN), such as after earthquakes events that cause damage to the UDN. For example, the UDN can include a water distribution network (WDN), an electrical power distribution network, a gas distribution network or other utility (public or private). A UDN resilience evaluation framework is firstly developed, which integrates the dynamic evolution of UDN performance indicators during the post-damage recovery process. The UDN performance indicator considers the relative importance of the service nodes and the extent of post-damage utility (e.g., water, electrical power, gas delivery etc.) needs that are satisfied. As described herein, a graph convolutional network (GCN) integrates deep reinforcement learning (DRL) to provide a GCN-DRL model framework, in which the GCN encodes the information of the UDN, such as topology and operating characteristics. In examples described herein, the UDN is described as a WDN for ease of explanation and consistency. However, it is to be understood that the systems and methods described herein, including the GCN-DRL model framework, are equally applicable to other types of UDNs.

For the example of a WDN, the topology and performance of service nodes (e.g., the degree of water needs satisfaction) are inputs to the GCN. The outputs of GCN are the reward values (Q-values) corresponding to each repair action, which are fed into the DRL process to select the optimal repair sequence from a large action space to achieve highest system resilience.

As described herein, the GCN-DRL model can provide an output describing a sequence of repair actions to achieve high system resilience index (SRI) values and the fast recovery of system performance. Additionally, by using transfer learning based on a pre-trained model, the GCN-DRL model can achieve high computational efficiency in determining the optimal repair sequences under new damage scenarios. This novel GCN-DRL model features robustness and universality to support optimal repair decisions to ensure resilient WDN recovery after being damaged.

### Example 1

Multiple hazards occurred in recent years have drawn increasing attention to ensure the resilience of community infrastructures. Critical infrastructure networks, including the water distribution networks (WDNs), gas supply networks, transportation networks, and power grid networks, are the cornerstones for resilient community services (Karakoc et al., 2019). As critical infrastructure, WDNs play important roles in ensuring the quality of life and community functions. Buried pipelines have experienced a large number of damages during past earthquakes (Nair et al., 2018; Pudasaini and Shahandashti, 2018). For example, 3,039 pipe failures were identified after the Christchurch earthquake on Feb. 22, 2011 (Eidinger and Tang, 2014). The ‘effective’ completion of the total repairing work, which returned the WDNs service to the minimal level of satisfaction, took about 53 days (O'Rourke et al., 2014). Disruption of WDNs after earthquakes not only caused huge economic loss but also raised serious public health concerns. Efficient post-earthquake recovery of WDN improves the resilience of WDNs, which requires analyzing its seismic resilience and developing novel methods for resilience improvements.

The term ‘resilience’ is originally derived from the Latin word ‘resilo’ with the meaning ‘bounce back’ (Hosseini et al., 2016), which describes the ability of a system or material or physical structure to bear a disruption and return to its original performance. For a water distribution system (or other UDN), resilience can be described as its ability to resist disruptive hazards (such as natural or man-made hazards) and quickly restores its service after such disruptions. Correspondingly, the methods for resilience quantification can be broadly divided into two major categories, namely, surrogate-based resilience quantification method and performance-based resilience quantification method. The surrogate-based quantification method treats the WDNs as static systems (typically before disruption) without considering their time-dependent performance during or after the disruption. However, when it comes to the WDN post hazard management, the performance-based method can provide a more straightforward evaluation method and therefore has been widely used. Previous studies have proposed different system performance metrics and attack-recovery strategies to evaluate infrastructure resilience gave a detailed review of the related metrics. Some commonly considered factors for the system performance evaluation include the water availability, water quality, and network structure.

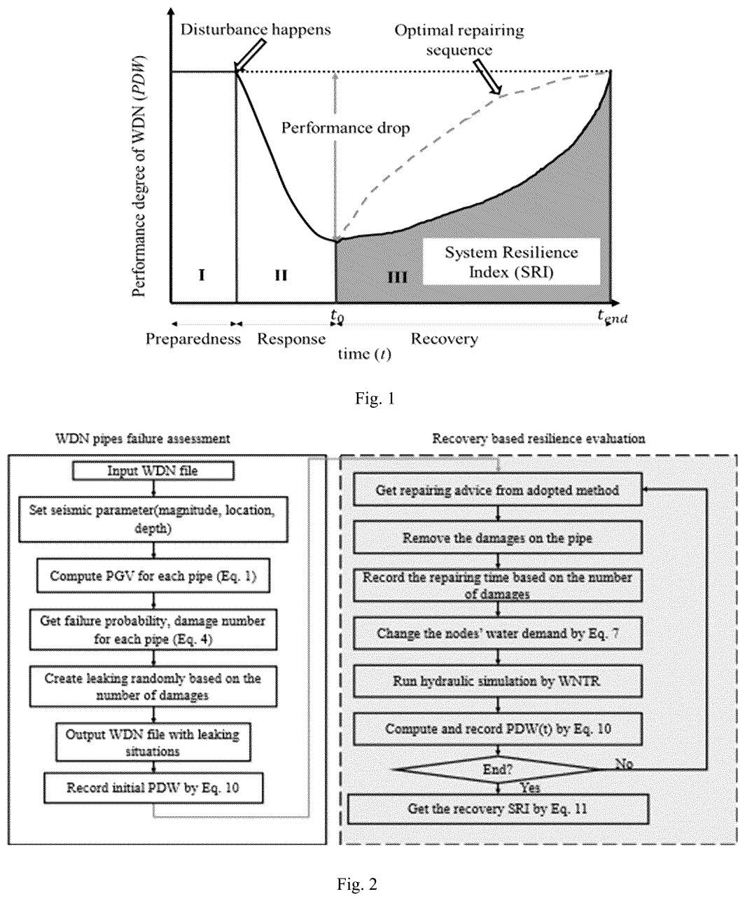

FIG. 1 is a graph showing a schematic illustration of the WDN performance-based resilience quantification. At each time step, a performance metric is used to evaluate the current system state, which can be divided into prior and post-hazard disturbance. For the post-hazard part, it can be further divided into response stage (Stage II) and recovery stage (Stage III). A common resilience quantified method is using the area under the curve as the system resilience index (SRI), as shown in the gray area of FIG. 1. In FIG. 1, t₀ and t_{end} denote the start and finish of a recovery process for a given episode.

The recovery decisions play an important role in the post-hazards WDN system performance recovery process or the WDN system resilience. As shown in FIG. 1, the faster the system recovers from disruption, the larger area under the recovery performance curve (defined as the System Resilience Index, or SRI), the more resilient the system is. Different decision models have been proposed in previous research to improve decisions on WDN system restoration sequence. However, due to the complex hydraulic relationships in a WDN and the stochastic characteristics of failures, determining an optimal restoration sequence to maximize the system resilience remains a challenging problem. Different methods have been developed to find the optimal WDN restoration sequence, which can be grouped into 1) general-purpose metaheuristic algorithms, 2) greedy algorithms, and 3) ranking-based prioritizations (Paez et al., 2020). These approaches, however, tend to be computationally demanding and time-consuming. These make the general-purpose metaheuristic algorithms generally only suitable for pre-defined damage scenarios.

As described herein, this disclosure further explores a novel post-hazard recovery decision-support framework by integrating the Graph Convolutional Neural Network (GCN) into Deep Reinforcement Learning (DRL) to determine the optimal WDN restoration sequence after an event that causes damage. As described herein, a damaging even can be a natural disaster (e.g., earthquake, tornado, flood, hurricane etc.) or a manmade event (e.g., an explosion or damage-inducing event). As used herein, the AI-based decision support model is referred to as the GCN-DRL model. The GCN-DRL model utilizes GCN to encode the topological and/or operational information of the UDN and uses the DRL framework to learn and identify the optimal restoration sequence that maximizes the SRI during the recovery process. In principle, this method belongs to the general-purpose metaheuristic methods that solve the global optimization problem. However, the GCN-DRL model can take advantage of the transfer learning strategy, where the pre-trained GCN-DRL model can be extended for new disasters. The systems and methods described herein can significantly reduce the computational time for new damage situations, which is crucial for fast emergency responses.

In the following examples, the UDN is described as a WDN and the damage inducing event is an earthquake. In the following section Theoretical framework for post-earthquake performance recovery and resilience assessment of WDN system, a dynamic demand-based seismic resilience evaluation model is described, which consists of a model for assessing the damages of WDNs subjected to earthquakes, a model for WDN recovery, a model for WDN performance measurement, and a model for WDN resilience quantification.

In the section entitled, graph convolutional neural network integrated deep reinforcement learning model, the resilience evaluation model enable the performance of different repairing sequences that are determined by different optimization methods to be quantified. A background of Deep Reinforcement Learning (DRL) and Graph Convolutional Neural network (GCN) are also described. This is followed by the description of the detailed architecture of the proposed GCN-DRL ML model. The section entitled Case Study describes the application and performance of the proposed ML model for a widely used WDN testbed. The testbed is assumed to be subjected to different earthquakes so different damage situations can be generated. The final performance of different optimization methods under different seismic situations is also compared. The final section describes the benefits and example uses for the systems and methods described herein.

### Theoretical Framework for Post-Earthquake Performance Recovery and Resilience Assessment of WDN System

The system resilience index (SRI), which is defined as the integration of the time-dependent system performance degree (PDW(t)) during the post-hazard recovery process, is utilized to measure the system resilience (see FIG. 1). In the following examples, the water distribution network (WDN) is assumed to be subjected to earthquakes. However, damage to the WDN can result from any natural and/or man-made influence. The performance of the WDN system is indicated by its capability to meet the water use demands of customers after the earthquake. An analysis framework is developed for the WDN system seismic damage model, recovery model, and resilience assessment.

FIG. 2 shows the overall procedures to implement the proposed recovery-based resilience evaluation framework, which is used to evaluate the performance of different system repairing strategies. Details of these components are introduced in the subsequent sections. In an example, the overall procedures include:
1) A hydraulic model of the WDN is first constructed. This requires collecting the basic hydraulic information of the WDN needed for the hydraulic simulation, such as WDN topological connection structure, pipe length, water user demands, etc.
2) Then, the earthquake damages on the WDN are randomly generated based on the seismic vulnerability of the WDN. The damage here indicates the leakage point of each pipe. Thus, a pipe with a high failure probability may have more leakage points than that with a low failure probability. While a pipe with extremely low failure probability may have zero damage points. After determining the initial damage situation, a hydraulic simulation is conducted to obtain the initial WDN performance degree (PDW) after the earthquake before the recovery stage begins.
3) The system recovery model includes components that consider the dynamic changing of user water demand, pipe repairment, and system performance evaluation. At each time step, a damaged pipe is selected for repair by the adopted repairing strategy. The repairing time for a pipe is assumed to be dependent upon the number of leakages along the pipe. Once repaired, the leakages on the pipe are removed for the selected pipe. The user's water demand is changed and subsequently, the hydraulic simulation is conducted. The WDN performance degree (PDW) at each time step is determined based on the system performance evaluation indicator. The repairing process is repeated until all the damaged pipes are restored. The final system resilience index (SRI) is determined (see, e.g., Eq. 11).

To evaluate the performance of the developed GCN-DRL method (S1), the system recovery processes by this method are compared with four other methods for the repair strategies, including two greed search based methods (named S2 and S3 respectively) (Liu, et al., 2020), a genetic algorithm (GA) method (S4) (Zhang et al., 2017), and a diameter-based repair prioritization method (S5) (Balut, et al., 2018).

### WDN Seismic Damage Model

Various components of WDN, including pipes, tanks, pumps, and water treatment facilities, could all be subjected to different extents of damages by earthquakes. To simplify the analyses without the loss of generality, this description focuses on the repair sequence of distributed components (e.g., pipelines). The localized facilities (e.g., tanks, pumps, and water treatment facilities) are not considered in the analyses. Similar assumptions were also used in previous studies (Liu et al., 2020). A number of studies about the WDN response to seismic have been proposed (O'Rourke and Ayala, 1993; Alliance, 2001). The American Lifeline Alliance model (Alliance, 2001) is one of the most commonly used models. Moreover, several studies extended this model by considering factors such as previous non-seismic records, pipe deterioration (Fragiadakis and Christodoulou, 2014). In an example, the damage model proposed by (Mazumder et al., 2020) is used; though, other damage models can be used. The utilized damage model considers the relationship between peak ground velocity (PGV) and pipe repair rate to describe the pipe fragility curve. For the PGV estimation of an earthquake event, an empirical equation, Eq 1, proposed by (Yu and Jin, 2008) can be used in conjunction with the systems and methods described herein.

PGV=10^{-0.848+0.775M-1.884 log(R+17)} 1

where R is the distance from the epicenter (km) and M is the magnitude of the earthquake. With the information of PGV, the pipe failure probability with the consideration of pipe materials and deterioration by aging is determined by Eq. 2:

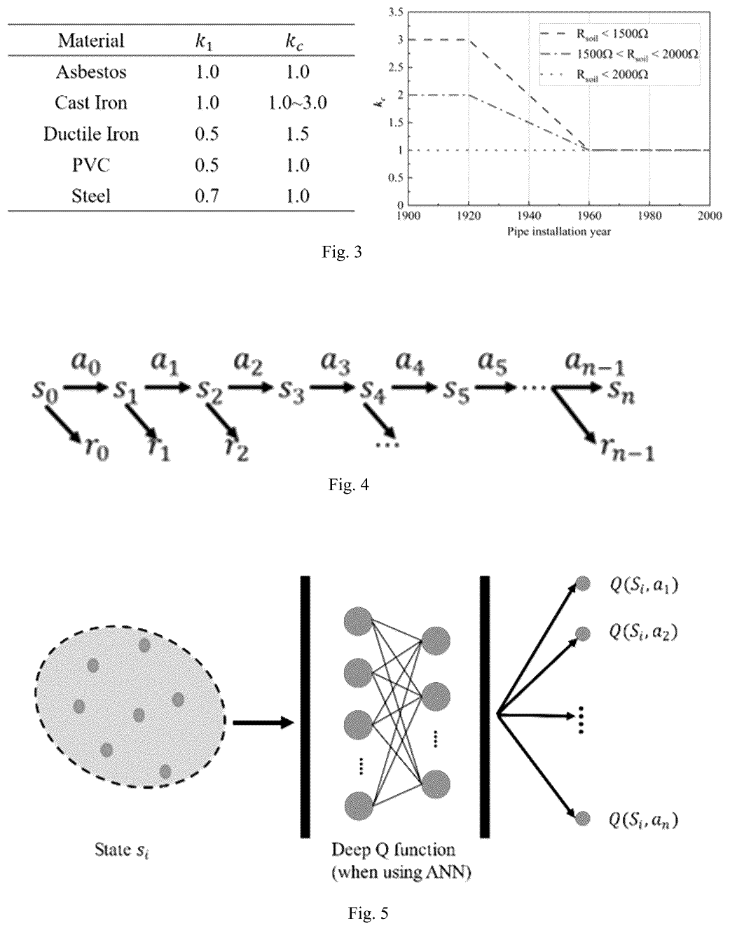

P(f)=1−e^{-k}^{₁}^{k}^{_{c}}^{·0.00187·PGV} 2

where P(f) is the pipe failure probability every 1,000 feet (304.8 m). k₁ is the correction factor by the pipe material, and k_{c} is are the correction factors that consider the effects of pipe material, size, soil type, (electrical conductivity), and age (deterioration). The recommended values of k₁, k_{c} for different pipes can be found in the sub-table in FIG. 3. k_{c} for cast iron is dependent upon the soil electrical conductivity and age.

Previous studies often use predefined damage status for each pipe, such as ‘leak’ or ‘break’, to describe the extent of damages. For example, (Paez et al., 2018) used different emitter coefficients for leaks and breaks. This description simplified the treatment of the extent of damage by using different numbers of leakage points along the pipe based on its failure probability. The larger the number of leakages, the more the pipe behaves like ‘break’ status and required a longer time to repair. The occurrence of leak numbers along a pipe can be assumed to follow Poisson's distribution (Cimellaro, et al., 2016)(Eq. 3).

$$P ( m ) = \frac{( λ ( \frac{L}{{L}_{0}} ) \text{?}}{\text{?}} \text{?} \qquad 3$$

$$\text{?} \text{indicates text missing or illegible when filed}$$

where P(m) is the probability of m damages occurring in the pipe; L is the total length of the pipe, L₀ is a reference length of 1000 ft (304.8 m).

The parameter λ of Poisson's distribution in Eq. (3) can be estimated based on the probability where no-failure occurs on the pipe by using Eqs. 4 and 5.

$$P ( m = 0 ) = 1 - P ( f ) = {e}^{- λ ( \frac{L}{L 0} )} \qquad 4$$

$$λ = - \frac{ln ( 1 - P ( f ) )}{( \frac{L}{L 0} )} \qquad 5$$

To determine the consequence of a seismic hazard, the number of failure locations along each pipe is randomly sampled with the corresponding Poisson distribution (Eq. (3)). The position of a pipe failure is assumed to occur at a random location along a pipe.

The effects of seismic damages on the operation of WDN are simulated by assuming that the damages will cause leakages in the pipelines. In principle, the leaking sizes may vary with the extent of damages to the pipes. For simplicity, the damages are simulated as leaks with the same leakage model as shown in Eq. 6. This, however, can be easily extended when more accurate information is available for a specific WDN. The seismic failure assessment of the water pipe network is coded by Python scripts.

dₗₑₐₖ=C_{d}A\sqrt{2gh} 6

where dₗₑₐₖ is the leakage water flow; A is the leakage area; C_{d} is the discharge coefficient; h is the water pressure at the leakage point. For instance, the discharge coefficient is used 0.75 by assuming a turbulent flow (Lambert, 2001), and the leakage area A is selected based on an empirical equation A=π·0.25%·d² (Shi and O'Rourke, 2008).

The hydraulic conditions of the WDN under normal operation and post-earthquake failure conditions are simulated by the hydraulic simulation solver WNTR (Klise et al., 2020). WNTR is an open-source python package for hydraulic simulations of the water pipe system, which solves similar sets of hydraulic equations as EPANET 2.2 (Rossman, 2020). By treating earthquake damages and repair as the proper boundary conditions, the water pressure at any location in the WDN can be determined.

### WDN System Recovery Model

As only pipe damages are considered in the WDN system damage model, the only action at each timestep is to decide which pipe should be repaired. However, more types of actions can be considered by extending this framework (such as close valve, pipe replacement, pipe inspection, etc.), as long as the influence on pipe hydraulic conditions and repair time are available. The systems and methods here can also considers the possible dynamic change of user's water demand during the recovery process. Didier et al. (Didier et al., 2018) studied the post-earthquake water demand behaviors after the 2015 Gorkha Earthquake. The results indicated that the expected water demand decreased significantly when subjected to a high level of damages to buildings and equipment. Although the buildings and equipment restoration should be independent of the WDN restoration process, it can be assumed that the user expected water demand is restored to the level before the earthquake, which is a simplification due to the lack of data. Specifically, a quadratic model is assumed to describe the time evolution trends of water demand post-earthquake, namely, a disruption and then recovery process in Eq. (7).

$$\text{?} ( t ) = \{ \begin{matrix}( \frac{t}{{t}_{total}} \text{?} * \text{?} & t > 0 \\ 0.0001 * \text{?} & t = 0\end{matrix} \qquad 7$$

$$\text{?} \text{indicates text missing or illegible when filed}$$

where Dᵢ⁰ is the expected water demand before the earthquake; t is the time step during the recovery process and t=0 corresponds to the time when repair of pipes starts.

It is assumed that users will still use a small amount of water even when the facilities are damaged at the beginning. t>0 corresponds to the recovery period. tₜₒₜₐₗ is the total recovery time, which is determined by the initial damage situation or the total number of pipe failures due to the earthquake hazard.

To consider the influence of water leakages, the pressure-dependent hydraulic model is adopted. The real-time water supply to each node on the WDN is determined by the expected water demand and the actual water pressure. The relationship between the real-time water supply (Dᵢ) and the expected water demand (Dᵢ⁰) is shown in Eq. (8) (Wagner et al., 1988). The hydraulic simulation is conducted at each time step after a selected pipe is repaired.

$$\text{?} ( t ) = \{ \begin{matrix}0 & {p}_{i} < {p}_{0} \\ \text{?} {( \frac{{p}_{i} - {p}_{0}}{\text{?} - {p}_{0}} )}^{\frac{1}{2}} & {p}_{0} \leq {p}_{i} \leq \text{?} \\ \text{?} & {p}_{i} > \text{?}\end{matrix} \qquad 8$$

$$\text{?} \text{indicates text missing or illegible when filed}$$

where pᵢ is the actual water pressure at the node, the p₀ is the predefined lower bound of water pressure (under which no water is supplied); pᵤ is the upper bound of water pressure (the minimum pressure to ensure water supply to meet the design water demand). In an example, p₀ and pᵤ are set as 0 and 30 meters as recommended by (Zhou et al., 2019).

To focus on the key problem without loss of generality, the following assumptions are made in developing a decision support model for the optimal repair sequence to restore the WDN service.

Repair time for pipe damages: Different types of damaged pipes may require different repairing times. For example, the Federal Emergency Management Agency provided the estimated repairing time of different WDN components (Federal Emergency Management Agency, 2003). To simplify the analyses, it is assumed an equal amount of time is needed to fix a leakage point in a pipe. With this assumption, the repairing time of each pipe is determined by the total leakage locations alongside this pipe. The number of leakages along a given pipe is affected by the pipe material, age, soil type, location, and uncertainty (e.g., Poisson distribution) (See Eqs. 3-5).

Binary working status of damaged pipes: The typical pipe repairing process involves closing the pipe end connections. A damaged pipe is re-open only when all repairs along this pipe are finished. It can be assumed that a damaged pipe is either closed (when damaged) or open (when repaired) based on the status of the repair. This assumption simplifies the hydraulic model of the WDN. In other examples, a multi-bit variable can be used to represent the status of pipes and other components within the WDN.

Resource for repair: A single repair team can be assumed, in which the WDN is repaired with one repairing team with no resource limits. No parallel repairs by multiple team is considered. This is also a common assumption used in prior research in determining the optimal recovery sequence of WDN (Almoghathawi et al., 2019; Liu, et al., 2020). This assumption ensures the failed pipes are recovered sequentially one by one. However, it is noted more sophisticated assumptions on the number of repair teams and their work efficiency can be incorporated.

Non-preemptive recovery: It is assumed that the repairing team has to finish the repairing work on the current pipe before moving to repair the next pipe. This assumption is often used in analyzing infrastructure repair processes such as roads, bridges, and power grids, etc.

Dynamic changing post-earthquake water demands: The water demand at each node of WDN is assumed to gradually restore to the pre-hazard condition as the restoration of WDN continues. A single post-hazard dynamic water demand recovery process can be used. It is noted that different nodes in the WDN could experience different dynamic water demand restoration process depending upon the function and location of the nodes. However, multiple dynamic water demand patterns can be easily added when such data is available.

### WDN System Performance Evaluation Model

The performance of the WDN is measured by its capability to meet the customers' water use demands. Given the essential role of clean water supply to public life, it should also be one of the most important criteria for post-hazard restoration decisions (Romero et al., 2010). In an example, the water user nodes satisfaction degree (NSD) is used to quantify the performance of the WDN system. Other measures of node performance can be used. The NSD is defined as a ratio of the expected water use at the node and actual water supplied to the node (Eq. 9). NSD value larger than 1 is assumed to be 1 (or water demand at the node is fully met). An example NSD measure is defined as follows.

$${NSD}_{i} ( t ) = \{ \begin{matrix}1 & {D}_{i} ( t ) \geq {D}_{i}^{0} ( t ) \\ \frac{{D}_{i} ( t )}{{D}_{i}^{0} ( t )} & {D}_{i} ( t ) < {D}_{i}^{0} ( t )\end{matrix} \qquad 9$$

where Dᵢ(t) is the actual water supply to the node at t; Dᵢ⁰(t) is the expected post-earthquake water demand at t. The units of both two variables are flow rate (m³/s).

Based on the NSD defined for each node, the overall degree of performance of a complete WDN is defined as the performance degree of the water network (PDW), which is calculated as the weighted sum of the NSD at each node in the WDN (Eq. 10). The weight factor considers the relative importance of the node. Using NSD to measure the overall WDN performance allows considering the importance of critical water supply nodes by assigning appropriate weight to the nodes (see Eq. 10). For example, restoring water supply to critical facilities such as hospitals, firefighting stations, schools, etc. is more critical than less safety-critical facilities. The important nodes can be prioritized in the restoration plan by assigning proper weights to the NSD, which can be considered for the seismic consequence analysis.

$$PDW ( t ) = {\sum }_{i = 1}^{n} {w}_{i} * {NSD}_{i} ( t ) \qquad 10$$

where NSDᵢ(t) is the node satisfactory degree at time t which belongs to (0, 1]. the wᵢ is the weight factors that consider the relative importance of the nodes ωᵢ; the weight factor for each node i is calculated by

$${w}_{i} = \frac{{ω}_{i}}{{\sum }_{j = 1}^{n} {ω}_{j}} ,$$

where n is the total number of service nodes.

The weight of a node wᵢ should be subjected to Σᵢ₌₁ⁿwᵢ=1. Therefore, the PDW at any time t falls within the range [0, 1].

As some prior studies indicated, the weight or importance of a water supply node may also change during the restoration process. Thus, in some examples, the node feature data can be expanded to quantify the importance of different nodes (e.g., a relative or absolute importance). For instance, a pre-defined fixed weight for each water supply node can be used in the systems and methods described herein. Other weights can be used for supply nodes in other examples. Dynamic changing of node importance can be considered by using the proposed framework, which is similar to the consideration of the dynamic changing of user's expected water demands.

### WDN System Resilience Index and Resilient Restoration

Based on the definition of the time-dependent system performance degree, PWD(t), (Eq. (10)), the system resilience index (SRI) during the recovery process is defined using the area of under-recovery curve of PWD(t) (Figure. 1), such as shown in Eq. (11):

$$SRI = \text{?} PDW ( t ) dt = \text{?} PDW ( t ) \qquad ( 11 )$$

$$\text{?} \text{indicates text missing or illegible when filed}$$

where t_{end} is the time of ending recovery; t₀ is the time of beginning recovery; the integration is normalized by (t_{end}−t₀) to consider the effects of recovery time.

To obtain a resilient restoration plan, the repairing sequence of damaged pipes is expected to achieve a higher SRI value at the end of the recovery process. For example, the SRI function (Eq. 11) can be used as the optimization objective. Also, or as an alternative, other standards can be used for optimization. In either case, the problem can still be taken as a single objective optimization problem by assigning appropriate weights to each standard.

To obtain a resilient restoration plan, the repairing sequence of damaged pipes is expected to achieve a higher SRI value at the end of the recovery process. For example, the SRI value is set as the optimization goal (e.g., maximization of SRI by proper decision sequence). It is noted some of the previous studies used different measurements of the recovery-based system resilience, these resilience measurements can be easily adapted as the optimization goal.

### Optimal Restoration Problem

Given the aforementioned description of the seismic damage model, recovery model, and evaluation model, the efficiency of different decision-making methods can be easily quantified by using the SRI value (Eq. 11). Hence, the optimal restoration problem can be defined as finding the most optimal repairing sequence that can achieve the highest SRI value. Mathematically, the problem of optimal repairing sequence is defined in Eqs. 12 to 14. Eq. 12 defines the main objective function for optimization, which aims to maximize SRI given a decision vector a. The decision vector is the repairing decision at each time step (a₀, a₁, . . . , aₜ_{_{end}}). Eq. 13 and Eq. 14 define the constraints when solving the optimization problems, These equations can be used to control that repairing decision at each time step should not be repeated, and the union of repaired decisions should equal the set of damaged pipes.

argmax SRI(α) 12

where:

a₁≠a₂≠a₃. . . ≠aₜ_{_{end}} 13

a₁∪a₂∪a₃, . . . ∪aₜ_{_{end}}=K 14
where SRI(⋅) is the resilience of WDN with the given repairing sequence a; αₜ is the selected pipe for repairing in time step t; K is the set of damaged pipes due to the hazards.

### Graph Convolutional Neural Network Integrated Deep Reinforcement Learning Model

Deep Reinforcement Learning (DRL) and Graphic Convolutional Network (GCN)

Deep reinforcement learning (DRL): DRL is an impactful development in Machine Learning (ML) model. It provides a powerful new approach to solve optimization problems based on a series of actions. DRL achieves promising results to identify the optimal action sequence from a massive set of action spaces and based on the corresponding system states and interactions with the environment. Andriotis and Papakonstantinou (2019) provided a detailed introduction about the successful DRL applications in the management system. DRL has also been successfully applied in areas such as vehicle control (Wang et al., 2020) and pavement maintenance (Yao et al., 2020), which have proven the ability of DRL for global optimization problems with high efficiency.

For the WDN restoration, the problem of optimal repair sequence is a global optimization problem. A decision-maker is expected to decide which pipe should be repaired under the current system state and then make the next decision based on the next system state. This problem can be illustrated in FIG. 4, in which sₜs, ∈s is the states of the system, a, ∈K is the space of action, r₁ is the reward of action αₜ when the state is sₜ. At each time step, the agent makes a decision on which pipe should be repaired, namely, αᵢ, from the defined action space K (the set of damaged pipes). In This action changes the system state from sᵢ to sᵢ₊₁ as the NSD of each point changed due to this repairing action. In the meanwhile, the system will feedback a reward η to reward the agent based on how good this action is to positively change the system state. To achieve a global optimal repairing sequence, the agent should not only consider the instant reward of each action but also considers its potential influence in the future. However, such a decision-making process is extremely challenging for humans as the influence of current decisions on the future is hard to be quantified. To overcome this challenge, the reinforcement learning algorithm is utilized to evaluate the performance of each action based on its instant reward and future reward.

Unlike the greedy search-based method which only computes the instant reward, reinforcement learning gives a Q value to each action under different system states. For example, the system state is represented by the node satisfactory degree (NSD) value and considering the system topological structure (e.g., defined by the WDN model data). According to the theory of reinforcement learning (RL), the Q value integrates the action's instant reward and the max Q value of the next state after taking this action. Such a Q value is defined as the Bellman equation (Bellman, 1952) as shown in Eq. 15. As demonstrated by (Mnih et al., 2013), by iteratively sampling all the actions under all the states, the RL model will compile the Q values of each action under each state to get a Q table. Then, the RL model determines the most optimal action by choosing the action with the highest Q value.

$$Q ( s , a ) = \text{?} [ \text{?} + γ \cdot \text{?} ] \qquad 15$$

$$\text{?} \text{indicates text missing or illegible when filed}$$

where the [symbol] denotes the expectation of Q value (Sutton and Barto 2018), r is the immediate reward after taking action a, and γ is the return discount for future rewards by following optimal policy of next state sᵢ₊₁. Q°(s′,a°) indicates the Q values of all the actions at next state s′.

However, for most real-world problems, the aforementioned Q table is extremely hard to obtain due to the infinite number of combinations of states and actions. For the WDN restoration problem, 50 damaged pipes could lead to 50! possible restoration sequences. To overcome this challenge of searching for the optimal action from an infinite large action space, Deep Reinforcement Learning (DRL) is proposed. For example, the DRL seeks to leverage the advancement in deep learning to solve the traditional RL problem Mnih et al. (2013), as shown in FIG. 5. Moreover, a deep Q function is utilized to estimate the Q value of each action based on the current system state. Hence, such a deep Q function should have the ability to interpret the current system state and approximate Q value of each action. Traditional DRL typically uses common types of artificial neural networks (ANN) as the Deep Q function. However, the ANN models typically use tabular type of input data. They are not effective when dealing with graph type of data such as the data from infrastructure network. To further advance this domain, a graph convolutional neural network (GCN) is used as the Deep Q function to encode the network structure of WDN and the corresponding data.

Graph convolutional neural network (GCN): The graph convolutional neural network (GCN) is a special neural network that can directly operate on graphic structural data, such as used to encode UDNs. The GCN utilized the key ideas of a CNN, such as local connection, shared weights, and the use of multi-layers. It, however, convolves the neighborhood's feature of each node, which overcame the limitation of CNN that can only perform on regular Euclidean data such as image (2D) and text (1D).

In the decision-making process, understanding the relationships in the current graph structure plays the most important part when targeting a global optimization. However, unlike some local optimization methods, there is no determined mathematical equation can be used in this process. By integrating the GCN-DRL and WDN recovery model, the parameters inside the GCN can be trained to obtain a global optimization decision. Specifically, the input of the GCN is the current state of WDN, including the WDN structure (including pipe length and connection matrix), and the satisfactory degree of each node (Eq. 9). The output of the GCN is a matrix of vectors that represents the understanding of the current WDN by the GCN. Such output is difficult to be interpreted but it will be transformed into a list of action scores by the following neural network layer. The process is introduced in the following section.

In an example, the graph convolutional neural network (GCN) implemented by (Kipf and Welling, 2016) is utilized for WDN network analysis. Other implementations of GCNs can be used in other examples. The layer of GCN performs a convolutional process on a graph-structured dataset. Unlike the traditional 2-dimensional convolutional process of CNN which focused on extracting the feature via a selected convolution filter, the GCN layer conducts the feature extraction of each vertex and its neighbors. Therefore, the structure of the graph is considered. Mathematically, a graph convolutional layer in GCN will project the nodes of the WDN network into a latent space by using Eq. 16.

$${H}^{l + 1} = σ ( \text{?} {H}^{l} {W}^{l} ) \qquad 16$$

$$\text{?} \text{indicates text missing or illegible when filed}$$

where:
H^{l} is input to the l^{th} layer of GCN neural network. At the input layer l=0, H⁰=X. where X is the feature matrix of the graph whose dimension is n×D, N is the number of nodes, D is the number of features of each node;
Ā=A+I, where A is the representative description of the graph structure. An adjacency matrix is used to describe the graph structure. I is the identity matrix with the same dimension as A;
\tilde{D} is the diagonal node degree matrix of Ā;
σ(⋅) denotes the activation function. The commonly used Relu activation function can be used;
W^{l} is the weight matrix of the l^{th} layer.

The input to the GCN is the feature matrix of the graph, X, whose dimension is N×D, N is the number of nodes, D is the number of features of each node. In an example, one feature is used for node attribute which is the node satisfactory degree (NSD) defined in Eq. 9. The output of the GCN is a matrix that contains the embedding information of the current WDN by the GCN. Each row of the matrix represents the latent space value of each node. The number of rows equals the number of total nodes in the WDN.

### Proposed GCN-Integrated DRL Model

A GCN integrated DRL (noted as GCN-DRL) model is configured to optimize WDN recovery by combining the GCN and DRL. The systems and methods integrate GCN and DRL to extract information from a water distribution network and make optimal decisions for post hazards recovery (e.g., restoration and repairs).

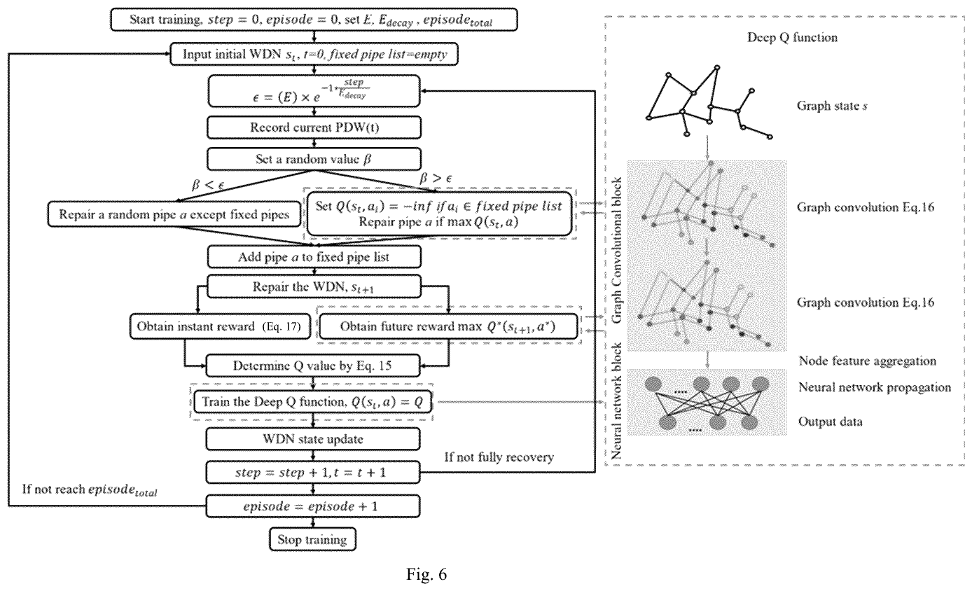

An example architecture of the proposed GCN-DRL model is shown in FIG. 6. The left side of FIG. 6 illustrates an example of a reinforcement training framework (DRL) programmed to train the deep Q function, and the right side of FIG. 6 provides an example architecture of the proposed deep Q function that integrates two GCN layers and one neural network layer. In FIG. 6, step: record current training times, episode: one recovery revolution, E: initial value of ϵ, E_{decay}: decay rate of during the training process, episodeₜₒₜₐₗ: total training revolutions, sₜ: WDN state at time t, β: random value, and α: pipe id for repairing.

The example framework of FIG. 6 can be implemented as follows:
1) At the beginning stage, the parameters that are used to control the training process should be initialized—the E, E_{decay}, and episodeₜₒₜₐₗ. The first two parameters are used to determine ϵ. This ϵ is used to control the probability of ‘taking actions randomly’ and ‘taking actions based on deep Q function’, which is also known as epsilon-greedy policy (Wiering and Van Otterlo, 2012). The benefit of taking random actions is that this process could prevent the agent from being trapped by the local optimal solution especially when its experience is limited.
2) A fixed pipe list is also initiated to record fixed pipes. This list is used to prevent any pipes from being repaired repeatedly. As shown in FIG. 6, a pipe is either randomly selected from the remaining failure pipes or determined based on the deep Q function. For example, the output of the proposed deep Q function is a list of repairing scores. Hence the pipe with the highest repairing score will be selected. This is the first time interaction between the deep learning framework and the deep Q function as shown by the top arrow in FIG. 6.
3) The WDN is repaired based on the selected pipe. Consequently, the hydraulic situation of the WDN is changed. The supplied water of each node is recalculated by running the hydraulic simulation (section 2.2), in which the next state sₜ₊₁ of the WDN is obtained.
4) Two reward values can be used to determine the award score (Q) of each action, namely, the instant reward function and the future reward function (Eq. 15). The instant reward can be set proportional to the improvement in the performance degree of WDN (PDW) with the consideration of repairing time (Eq. 17). The WNTR model is used to calculate PDW of the current state and one-step forward stat. The future reward is obtained by feeding the updated state of WDN into the deep Q function and get the maximum output. This is shown by the middle arrow in FIG. 6.
5) After obtaining the instant reward η and potential future reward (max Q°(s′,a°)), the Q value of the selected action will be computed by Eq 15. Then it is fed back to the deep Q function to train the inside neural networks. Such future reward is inaccurate at the beginning; however, with the training process development, this predicted value will be closer to the real Q function. This process is shown by the bottom arrow in FIG. 6.
6) The training process will be repeated with a number of episodeₜₒₜₐₗ. Each episode denotes a full recovery revolution which contains a trial repairing sequence. The WDN state is also updated whenever an action is made. This trial-and-error process can be seen as a process mimicking an export accumulating the experience. For each integration, the parameters of the neural networks are calibrated and updated by the backward propagation process.

The integrated deep Q function is shown on the right side of FIG. 6, which contains two layers of GCN and two layers of ANN. As the output of the GCN layer is a matrix of N×D (refer to Eq. 16), it cannot be directly fed into the following ANN layer. Inspired by the Convolutional Neural Network, we aggregate respective node values (e.g., by averaging the node values) to provide a GCN output that constitutes a one-dimensional vector space. The GCN output is then feed into the ANN layer.

The detailed architecture of the deep Q function emulated by the GCN is described as following. The input to the deep Q function is the WDN state, which is a graph structure data represented by the network structure and nodes satisfactory degree (NSD). It is projected by the first graph convolution layer with 64 dimensions. The outputs are then projected to 128 dimensions by the second GCN layer. The output of the 2nd GCN layer is aggregated by taking the average values of the projected node attribute in each dimension, which is 128 dimensions as well. Then this vector is fed into a neural network. The first layer of the neural network contains 128 neurons to accept the input data of 128 dimensions. The number of neurons in the second layer or the output layer of the neural network equals the dimension of the action space, which is the total number of initially damaged pipes. A linear activation function is used in the last layer of the neural network.

$$r = \frac{{PDW}_{i} ( t ) - PDW ( t - 1 )}{{T}_{i}} \qquad 17$$

where PDWᵢ(t) is the degree of performance of WDN after taking repair action i: PDW(t−1) is the degree of performance of WDN after previous repair action; Tᵢ is the duration needed in repairing pipe i. The repairing time can be determined by the number of leakages in the damaged pipe.

The trained GCN-DRL model thus can be used to determine the pipe repair sequence. To achieve a smooth and stable training result, the technique ‘Experience replay’ described by (Mnih et al., 2015) can also be used. The graph neural network and reinforcement learning used in the systems and methods described herein can be implemented by the python deep graph library (Wang et al., 2019) and PyTorch library (Paszke et al., 2019).

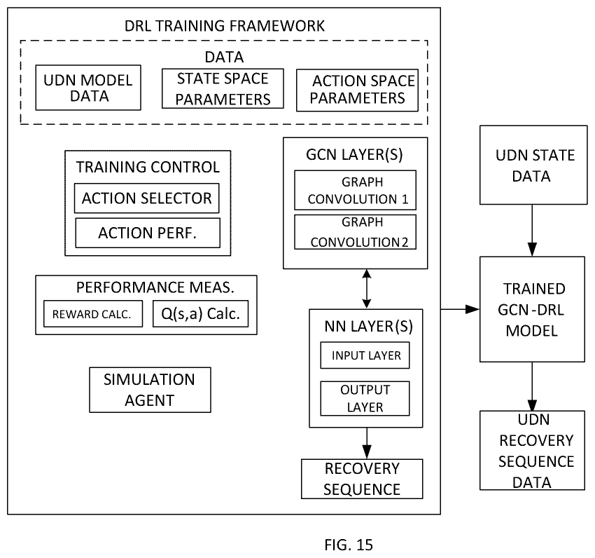

FIG. 15 is a block diagram of a system shown an example architecture for a GCN-DRL model that can be used to facilitate repair decisions for a utility distribution network (UDN). FIG. 15 is a functional block diagram of an example system that can be used to perform the functions described herein, including those of FIG. 6. Accordingly, reference can be made back to FIG. 6 as well as other parts of this disclosure during the description of FIG. 15.

The UDN can include a WDN or any other type of UDN. One or more non-transitory computer-readable memory can be programmed to store data and instructions. The data can include including UDN model data, state space parameters and action space parameters. The UDN model data can be representative of a structure of the UDN having a plurality of nodes and parameter data characterizing features and connectivity associated with each node of the UDN structure. For example, the state space parameters (which can be part of the UDN model data) describe features associated with each node, such as including information representing connectivity, importance, condition of nodes and/or connections, size, capacity, age and the like. In the system of FIG. 15, one or more processors are configured to access the memory and execute the instructions to provide a reinforcement learning framework and provide a trained GCN-DRL model.

The framework includes a graph convolutional neural network (GCN) programmed to encode the structure of the UDN. The GCN is programmed to project nodes of the UDN structure into a multi-dimensional state space according to the UDN model data and the parameter data and to provide GCN output data responsive to an input representative of at least a current state of the UDN (e.g., as represented in updated version of the data) and one or more actions (e.g., selected from action space parameters). As described herein, for a WDN, the GCN is configured to encode structural information for the water distribution network. The GCN output data can be provided by aggregating an output for each node dimension of the GCN, such as described herein.

A neural network, which is connected to the GCN, includes an input layer and an output layer. The input layer is programmed to receive the GCN output. The output layer is programmed to provide a sequence of recovery actions based on a current state space of the UDN model data. In an example, the GCN is programmed to provide the GCN output as a matrix representing at least one state space value for respective parameters of each node of the UDN model, and the framework is further programmed to convert the matrix into a corresponding vector that is received by the first layer of the neural network.

The framework can include one or more performance calculators programmed to determine a measurement of the performance of the UDN in response to each of a plurality of recovery actions applied to the UDN model data for a current state space of the UDN over time. The performance calculator can be programmed to determine the measure of performance of the UDN responsive to each of a plurality of respective recovery actions for a respective episode of recovery actions based on the current state-space and a next-state space for the UDN.

The measurement of performance for each recovery action can be applied to train the neural network. Further, the training can be repeated over a number of episodes, in which the state space parameters for the UDN are updated for each of the episodes. The framework is programmed provide a trained GCN-integrated reinforcement learning model that is programmed to generate recovery output data representing a sequence of recovery actions for the UDN in response to input UDN state data representative of a current state of the UDN.

As a further example, the reinforcement learning framework can be further programmed to perform an analysis of distribution of a commodity through the UDN based on simulation for a sequence of recovery actions for one or more components of the UDN. The sequence of recovery actions can define a respective episode. In some examples, the performance calculator can compute the measurement of performance based on an ability of the UDN to meet consumer needs (e.g., by delivery and distribution of the commodity), such as determined by an output layer of the neural network responsive to a sequence of respective recovery actions in the state space over time.

In a further example, the performance calculator can be programmed to compute the measurement of the performance as a deep Q function, which has a Q value based on an instant reward component and a future reward component. In an example, the deep Q function can include the GCN and the neural network, and the deep Q functions provides the future reward component as a maximum future reward based on the updated state of the UDN. The Q value provided by the deep Q function can be used to train the neural network. The deep Q function can include a Q table or other structure to determine a respective Q value based on UDN state data and each respective action. The neural network can employ the GCN output to estimate the Q function based on a simulation environment implemented by the framework for the UDN, such as described herein.

### Example Case Study

### Case Study Rancho Solano Zone III WDN

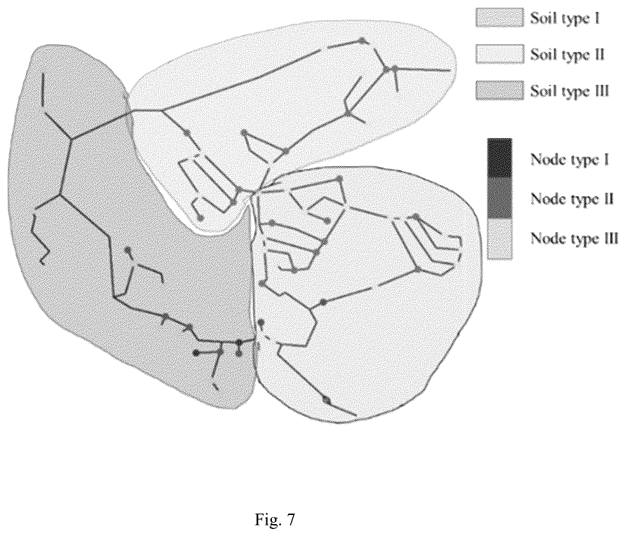

The GCN-DRL based repair decision-making model based on the recovery-based WDN seismic resilience evaluation framework is applied to analyze the seismic recovery of a testbed WDN located in Fairfield, California. The complete dataset about this WDN is publicly available from the database maintained by the University of Kentucky (Hernadez, et al., 2016). The original water demand and water supply conditions are used. The influence of pipe ages, materials, customer importance, and soil types is also considered in this case. The detailed information about the testbed is summarized in Table 1. The WDN structure, levels of node importance, and the soil types are shown in FIG. 7. These attributes of each pipe and the seismic PGV are used to obtain the damage probability of each pipe.

### Water Pipes Seismic Failure Prediction and GCN-DRL Hybrid Model Training

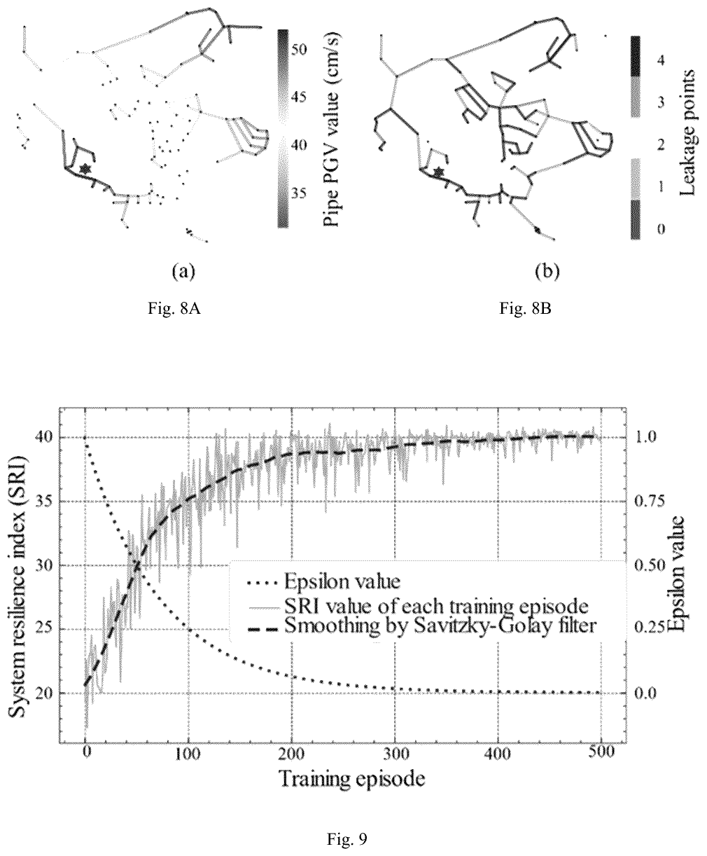

The WDN is first assumed to be subjected to a magnitude 6.5 earthquake with the epicenter located at the left bottom of the WDN (red star annotated in FIG. 8). The depth of the earthquake is assumed to be 5 km. The earthquake-induced Peak Ground Velocity (PGV) is calculated using Eq. (1) and shown in FIG. 8(a). The corresponding numbers of pipe damages are determined considering the influences of pipe material, pipe age, pipe length, and soil material based on the equations described in the earlier context (Eq. (1) to Eq. (5)). The final number of damages on each pipe is shown in FIG. 8(b). In summary, the earthquake causes 69 total damages points affecting 44 pipes. The initial performance degree of the WDN (PDW) immediately after the earthquake is computed to be about 0.00564.

TABLE 1
Summary of the information about the testbed

| | Variable name | Value | Description |
|---|---|---|---|
| WDN | Number of Pipes | 126 | Total number of edges |
| structure | Number of Nodes | 112 | Total number of vertices |
| | Node elevation | [90, 139] | This is predefined by the dataset |
| | (above sea level) | | |
| | (meter) | | |
| Pipes | Pipe length (meter) | [90, 1200] | This is predefined by the input |
| | | | file |
| | Pipe age (years) | [50, 100] | Randomly assigned to each pipe |
| | | | based on uniform distribution |
| | Pipe material | ‘Cast Iron’, | Randomly assigned to each |
| | | ‘Ductile Iron’, | pipe. |
| | | ‘Steel’, | |
| | | ‘PVC’, | |
| | | ‘Asbestos' | |
| Customers | Number of | 63 | Vertices whose basic water |
| | customers | | demand is larger than 0. |
| | Weights of | I: ω = 5 | Different types of customers. I |
| | customers (unitless) | II: ω = 3 | denotes the most important |
| | | III: ω = 2 | node and III denotes the least |
| | | | important. |
| Soil | Soil type | I: Rₛₒᵢₗ < 1500 Ω | Different types of soil, Rₛₒᵢₗ |
| | | II: 15000 Ω < Rₛₒᵢₗ < 2000 Ω | denotes the soil electrical |
| | | III: Rₛₒᵢₗ > 2000 Ω | resistivity. Distribution of soil |
| | | | type is shown in FIG. 7 |

The proposed GCN-DRL model is trained to repair the damaged pipes in the WDN according to the framework described in Section 3.2. Table 2 shows the key parameters used in training the GCN-DRL mode. The total episode of training (or the number of complete repair sequences) is set as 500. Since 44 pipes are damaged, this means the deep Q function is trained 22,000 times. The parameter ϵ, which determines if repair is by random decision or by RL learning, started with ε=1 and continues to decrease to a small value with progress in WDN repairment. The E_{decay} is set as 5000 so the ε value could be nearly 0 at the end of training (0.0122).

TABLE 2
Key parameters used for the GCN-DRL model

| Parameter | Description | value |
|---|---|---|
| ϵ | The parameter controls the probability of action taken by randomly or GCN based | $ϵ = E \times {e}^{- 1 \times \frac{step}{{E}_{decay}}}$ |
| E | The initial value of ϵ | 1 |
| E_{decay} | ϵ decay rate | 5000 |
| episodeₜₒₜₐₗ | Total revolution number for training. 1 | 500 |
| | episode means one complete recovery | |
| | process | |

FIG. 9 shows the SRI of the WDN system under 500 training episodes and the corresponding c values. The smoothing SRI is derived from Savitzky-Golay filter (Schafer, 2011) as shown by the dashed line. The control parameter c determines if the repair decision is made randomly (large ϵ) or from deep Q function (small ϵ). The results imply that the SRI values in the first 70 episodes are relatively low and unstable since the control parameter c is relatively large, these restoration actions are mainly randomly chosen (FIG. 9). As the training process continues, the control parameter c decreases so the probability of taking actions guided by GCN increases. The agent makes decisions mostly based on the GCN after around 350 episodes, which achieved stable solutions with high SRI values. The fluctuations of the SRI are due to the inherent randomness of the neural networks and the high dimensional state space.

### Some Description of Existing Decision-Making Methods for Pipe Recovery Sequence

The performance of the repair sequence by the GCN-DRL ML model is compared with four conventional decision-making methods, including two greed search-based strategies (S2 and S3) (Liu, et al., 2020), a GA method (S4) (Moscato, 1989; Zhang, et al., 2017) and a diameter based repair prioritization method (S5) (Balut, et al., 2018). Although other repairing methods have been used in the previous studies, most of the methods belong to these classes and are different variants of these four methods. The detailed mechanisms of these methods (named as S2 to S5) are briefly described as following:
S2: static importance-based method. This method prioritizes pipe repair based on ranking the improvements of the WDN performance degree (PDW) after repairing the pipe over the initial damaged status. The larger the ranking factor, the higher the priority the pipe to be fixed. The ranking factor of pipe i is defined as:

$${I}_{s , i} = \frac{{PDW}_{i} - {PDW}_{0}}{{T}_{i}} \qquad 18$$

where PDWᵢ is the performance degree of WDN after repairing pipe i; PDW₀ is the performance degree of WDN before any recovery; Tᵢ is the repairing time for pipe i, which equals the number of damages on the pipe.
S3: dynamic importance-based method. This method determines the pipe repair priority by the dynamic importance during the recovery of the WDN. Unlike S2 which only compares the performance improvement with the initial damage status, S3 compares the performance between the pipe recovery and current WDN state by the following equation. The importance of pipe i is ranked based on I_{d,i}(t)

$${I}_{d , i} ( t ) = \frac{{PDW}_{i} ( t ) - PDW ( t - 1 )}{{T}_{i}} \qquad 19$$

where PDWᵢ(t) is the performance degree of WDN at time t after repairing pipe i; PDW(t−1) is the performance degree of WDN before at the last time step; Tᵢ is the repairing time for pipe i, which equals its damage number.

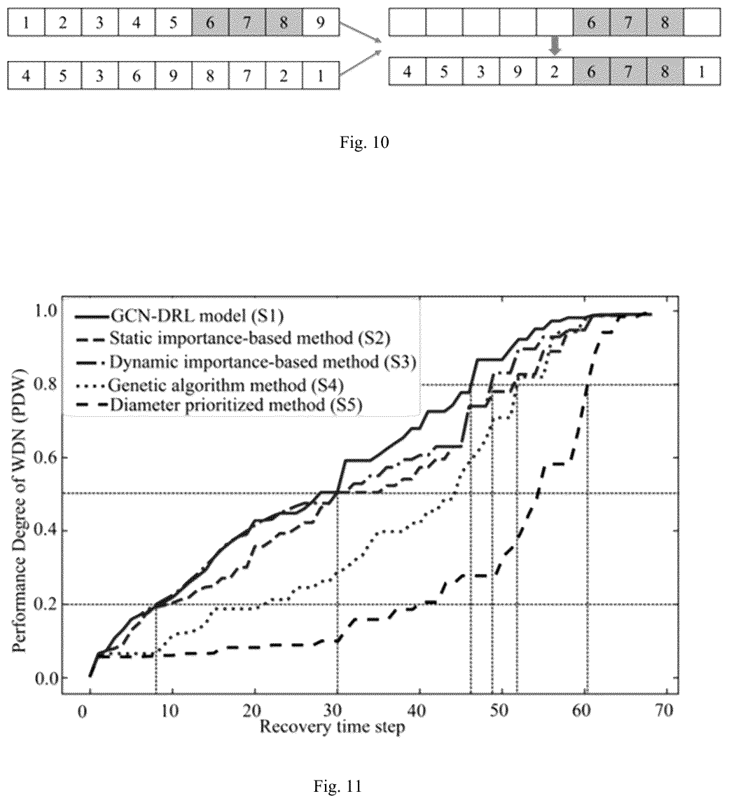

S4 Genetic algorithm (GA)-based method. Genetic Algorithm (GA) is a global optimization algorithm. As a combinatorial optimization problem, the crossover method proposed by (Moscato 1989) can be used, such as shown in FIG. 10. Firstly, a random subset of parent 1 is selected and filled into the sequence in parent 2. The mutation of each individual is performed by randomly exchange two genes with a very low probability. This probability can be set as 0.03.

S5 diameter-based repairing prioritization method. This method determines the repair sequence based on the ranking of the pipe diameter. The damaged pipes will be ranked based on the size of their diameter. The repairing sequence follows this ranked sequence.

### Evaluation of the Computational Performance

The computational performance of each method is evaluated by the final SRI value of the recovery trajectory, the recovery time to achieve a satisfactory level of system performance, and the computational time.

The recovery trajectories by using methods from S1 to S5 are shown in FIG. 11 and the corresponding SRI values are summarized in Table 3. Compared with conventional methods (S2 to S5), the proposed GCN-DRL method (S1) improves the area under the trajectory curve, which corresponds to a higher system resilience index (SRI) value. It is noted that the GA-based method (S4) is also a general-purpose metaheuristic method. The under-curve area of the recovery process by GCN-DRL (S1) is much larger than that by GA method (S4) even when the GA method used two times the number of trials. This result indicates the GCN-DRL outperforms the GA as a global optimization method for repair sequence.

The recovery time to achieve a satisfactory level of system performance is critical for infrastructure restoration. FIG. 11 also shows the recovery time to achieve certain performance levels of WDN based on repair sequences by different decision methods. The results imply that the repair sequences by S1, S2, and S3 achieved 20% and 50% performance degrees in a similar amount of time. After that, the repair sequence by the GCN-DRL (S1) method ensures the fastest recovery until the system is completely restored. The observations are attributed to that the developed GCN-DRL model (S1) can efficiently consider the future impact of repair decisions compared to greedy search methods (S2 and S3) and therefore achieve a global optimal repairing sequence. The performance of genetic algorithm (S4) lagged until the system recovers to about 95% of its original performance. Assuming 80% system performance is a satisfactory level, the proposed GCN-DRL method (S1) achieved around two time-steps ahead of S3 and around five time-steps ahead of genetic algorithms (S4). These demonstrate the superior performance of the GCN-DRL model in determining the optimal repair sequence compared to conventional methods.

The computational time to determine the repair sequence by methods S1 to S5 is also shown in Table 3. The GCN-DRL ML model takes more computational time than S2, S3, and S5 since a large number of training iterations are involved. For example, in this case, the GCN-DRL model takes 500 training episodes, each training episode contains 44 times of repairing process (44 damaged pipes). Therefore, 22,000 hydraulic simulations were conducted to capture the WDN performance. The deep Q function was also trained 22,000 times.

TABLE 3
SRI and computing time among different recovery methods

| Method | S1 | S2 | S3 | S4 | S5 |
|---|---|---|---|---|---|
| SRI | 41.67 | 36.977 | 39.225 | 30.868 | 26.464 |
| Time | 2.3 h | 3 min | 15 min | 3.2 h | 2 min |

To future demonstrate the robustness of the developed method, two additional earthquake scenarios with different epicenters or magnitudes are considered, named as the second scenario and the third scenario respectively. The second earthquake scenario is a magnitude 6.75 earthquake close to the center of the WND map, which caused 59 pipes to be damaged with 107 leaking locations. The third scenario is a magnitude 7 earthquake occurring at the top right, which caused 73 pipes to be damaged with 151 leaking locations. The initial PGV values and the corresponding water pipe damages under these two seismic scenarios are shown in FIG. 12. The same parameters as the first seismic scenario (e.g., pipe material, age, soil type, and consumer importance) are used in the damage and recovery analyses.

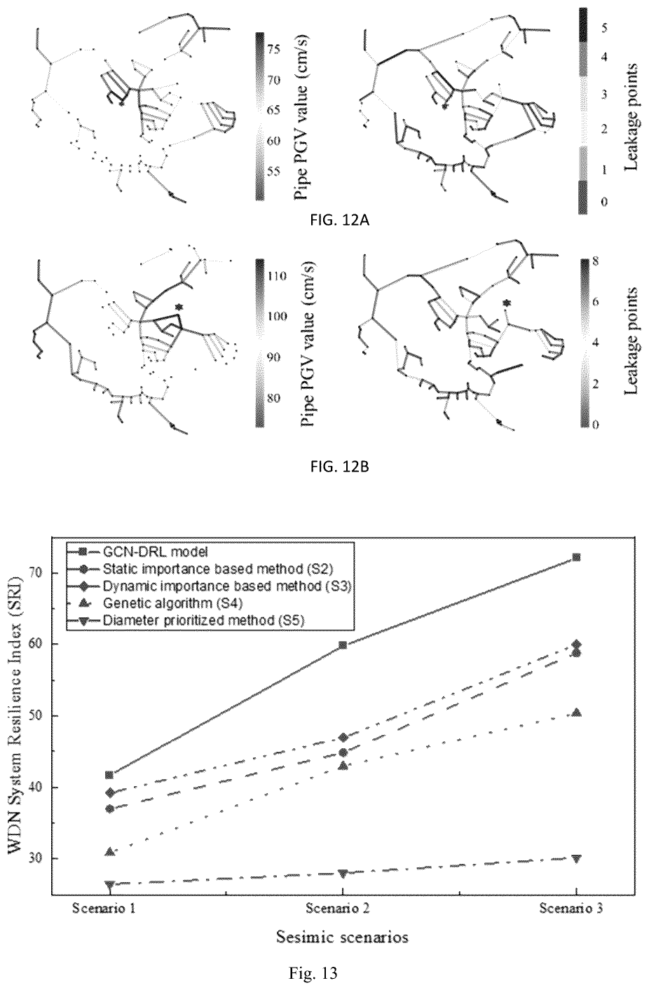

The final performance of system resilience, indicated by the final SRI values, of different repairing decision methods to recover from these three earthquakes, is summarized in FIG. 13. In FIG. 13, the following damage scenarios are shown: Scenario 1: 44 pipes damaged with 69 leakages, Scenario 2: 59 pipes damaged with 107 leakages, Scenario 3: 73 pipes damaged with 151 leakages), scenario 2: 59 pipes damaged with 107 leakages, scenario 3: 73 pipes damaged with 151 leakages. As shown, the GCN-DRL model consistently outperforms the other decision methods for all these earthquakes. It is also noted that the more severe the earthquake damages, the more significant the GCN-DRL model improves the final SRI values. Or the more benefits in improving system resilience via globalized optimal decisions with GCN-DRL model. Besides, compared with the other global optimization method. That is, the GA model, the GCN-DRL model is much more computationally efficient.

### Transfer Learning for Rapid Responses

As pointed out by Paez et al. (2020), the general-purpose metaheuristic algorithms require high computational demands. These make the general-purpose metaheuristic algorithms only suitable for pre-defined damage scenarios. Given the uncertainties associated with the exact damages during hazards, the high computational demand limits the applicability of this type of algorithms. A novel transfer learning strategy is explored for the GCN-DRL for new disaster scenarios. That is, when training the GCN-DRL model, the parameters of the deep Q function are saved as the ‘training experience’. Therefore, unlike conventional decision algorithms that need to start from scratch for each new damage scenario, the GCN-DRL model can use the ‘training experience’ from previous training results as long as the new damaged pipes have been considered in the training model. Consequently, high computational efficiency is achieved, which is advantageous for emergency response.

TABLE 4
Summary of SRI of WDN recovery based on repair sequence
by different methods as well as the corresponding
computational time for different damage scenarios

| | Performance | Scenario No. | | | | |
|---|---|---|---|---|---|---|
| Method | indicator | S1 | S2 | S3 | S4 | S5 |
| 1 (36 | SRI | 35.449 | 34.286 | 35.197 | 33.743 | 13.712 |
| damaged | Time | 6 min | 3 min | 15 min | 4.0 h | ~1 min |
| pipes) | | | | | | |
| 2 (31 | SRI | 33.243 | 31.746 | 32.414 | 29.674 | 20.406 |
| damaged | Time | 5 min | 4 min | 11 min | 2.6 h | ~1 min |
| pipes) | | | | | | |
| 3 (24 | SRI | 27.551 | 27.517 | 27.548 | 26.165 | 22.742 |
| damaged | Time | 4 min | 4 min | 10 min | 2.1 h | ~1 min |
| pipes) | | | | | | |

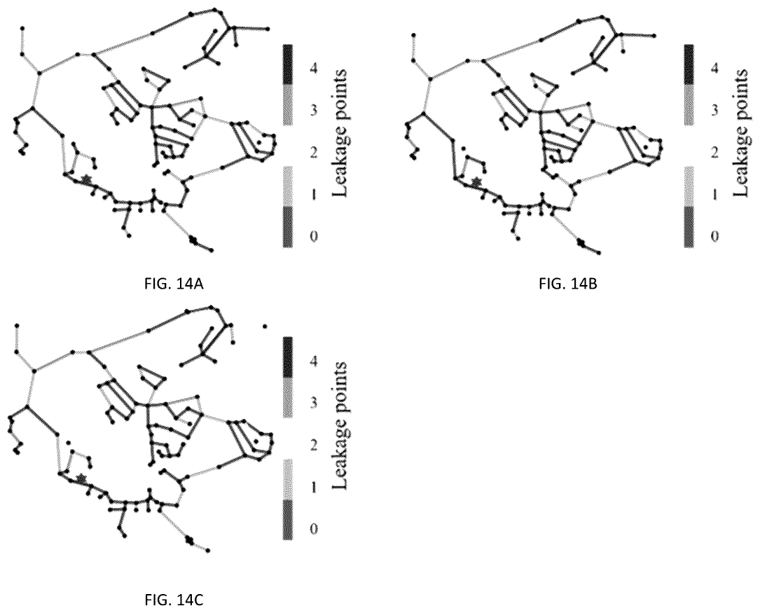

To demonstrate the benefits of transfer learning, the performance of the GCN-DRL model and computational time based on transfer learning for new damage scenarios is compared with those by the conventional methods. The new damages are randomly chosen from a subset of the predicted pipe damages (see FIG. 8B)) as the initial damage situation. FIGS. 14A, 14B and 14C show the selected damage situations with 36, 31, and 24 damaged pipes respectively. The ‘training experience’ of the pre-trained model described in section 4.2 is loaded to the GCN-DRL model (S1). Methods S2, S3, S3, and S5 are used for comparison purposes. The pre-trained GCN-DRL was trained with 10 episodes for each new WDN damage situation.

Table 4 summarizes the performance as well as the corresponding computational time to determine the repair sequence by different methods on the new damage scenarios. The require sequence identified by GCN-DRL model (S1) with transfer learning achieved the highest SRI value among all the methods, including the highest resilience. The SRI value of the repair sequence by S1 is larger than the other four repair methods by 1.16, 0.252, 1.706, and 21.737 respectively under the earthquake scenarios causing 36 damaged pipes. The SRI value based on repair decision by S1 improved by 0.034, 0.003, 1.386, and 4.809 respectively for the earthquake scenario causing 24 damaged pipes.

The results indicate that the larger the number of pipes damaged, the more advantages of GCN-DRL in achieving an optimal decision sequence than conventional methods. This makes sense since the larger the number of pipes damaged, the more difficult it takes to identify the global optimum with conventional methods. This is also an indication of the strength of the GCN-DRL model in making global optimal decisions among a large decision space.

In terms of the computational time for decisions, the use of transfer learning significantly reduced the time needed for the GCN-DRL model to determine the optimal repair sequence. The computational time is comparable to those needed by the greedy search algorithm and diameter-based prioritization method. It is noted that the GCN-DRL model significantly outperformed the GA method, another general-purpose metaheuristic global optimization method, both in terms of performance and computational efficiency.

### CONCLUSION

Optimal repair decisions play an important role in improving WDN resilience by accelerating the post-disasters recovery of the system performance. This description provides a novel artificial intelligence (AI) based decision-making model to achieve a resilience-oriented restoration plan. A resilience evaluation framework is firstly developed, which consists of a model for pipe failure prediction, a model for WDN performance measurement, and a model for WDN resilience quantification. The system resilience index (SRI) is proposed for the system resilience quantification, which is defined based on the time evolution of WDN system performance degree (PDW) during the recovery process. The PDW considers the node satisfaction degrees (NSDs), which measure the extent of the post-hazards dynamic water demands at WDN supply nodes are met, weighted by the relative importance of these nodes. With the system resilience indicator SRI, a novel Graph Convolutional Network (GCN) integrated Deep Reinforcement Learning (DRL) machine learning model (GCN-DRL) is developed to determine the optimal repairing decision. The GCN-DRL model combines the advantages of DRL and GCN. The GCN is used to embed the WDN including the topological connections and information of NSDs at each node. The DRL framework is used to train the GCN to learn and determine the optimal repair actions under a given damage situation.

The GCN-DRL model is demonstrated to determine the optimal repair sequence of a testbed WDN subjected to earthquake damages. Three different damage scenarios are analyzed considering the magnitudes of the earthquake, distance to the epicenter, soil type, pipe deterioration, etc. The performance of the pipe repair sequences by the GCN-DRL model is compared with the results by four traditional decision-making methods. The results show that the GCN-DRL model consistently identified repairing sequences that lead to the highest system resilience index (SRI) under different damage scenarios. Besides, the transfer learning strategy can be used to train the GCN-DRL model for new damage scenarios by taking the advantage of the prior training experience. The transfer learning strategy was demonstrated in three new damage situations of the WDN. The results show that the transfer learning of GCN-DRL decision-making model achieved the most resilient WDN recovery with significantly shortened computational time. Therefore, the new GCN-DRL model is promising to be a high-performance robust decision-support tool for post-hazard repairing decisions to ensure resilient WDN recovery. However, it is noted that the conventional methods such as S2 and S3 features simplicity and good interpretability. The proposed GCN-DRL model are more advantageous with increasing dimension of the decision space (associated with larger number of damages). As with most ML models, improvement of the interpretability is an area that requires further research.

It is noted that several simplified assumptions were used in the examples herein, which is intended to allow the analyses to focus on the most important contributions, namely, the development of the innovative GCN-DRL-based framework to support WDS recovery decisions. For example, the repairing time for the damaged pipe is assumed to be only dependent upon the number of leakage points along the pipe. However, a more advanced model for pipe repairing time and repair crew task assignment can be easily accommodated. The WDN examples herein focused on the damages and repair of pipes. Damages to the water towers or pump stations are not considered, although these are some examples of additional parameters that can be included in the training framework and models herein. The damage assessment and recovery analyses can readily incorporate other components of the WDS. The Water Satisfaction Degree (WSD) was used to quantify the serviceability of the post-hazard performance of the water distribution system. The systems and methods described herein can incorporate multiple measurement metrics to quantify the WDN performance. Overall, the GCN-DRL model framework is developed with scalability and generality in mind, which can be readily adapted to analyze different types of WDS and accommodate more sophisticated assumptions.

In view of the foregoing structural and functional description, those skilled in the art will appreciate that portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

It should further be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or application for purposes of clarity, it should be understood that the techniques of this disclosure may be performed by a combination of units or modules associated with, for example, a local or distributed system.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.”

All references, publications, and patents cited in the present application are herein incorporated by reference in their entirety.

What is claimed is:

1. A system to facilitate repair decisions for a utility distribution network (UDN), comprising:
non-transitory computer-readable memory programmed to store data and instructions, the data including UDN model data representative of a structure of the UDN having a plurality of nodes and parameter data characterizing features and connectivity associated with each node of the UDN structure;
one or more processors configured to access the memory and execute the instructions to provide a reinforcement learning framework, comprising:
a graph convolutional neural network (GCN) programmed to encode the structure of the UDN, in which the GCN is programmed to project nodes of the UDN structure into a multi-dimensional state space according to the UDN model data and the parameter data and to provide GCN output data responsive to an input representative of at least a current state of the UDN and one or more actions;
a neural network, connected to the GCN, including an input layer and an output layer, in which the input layer is programmed to receive the GCN output, and the output layer is programmed to provide a sequence of recovery actions based on a current state space of the UDN model data; and
a performance calculator programmed to determine a measurement of the performance of the UDN in response to each of a plurality of recovery actions applied to the UDN model data for a current state space of the UDN over time,
wherein the measurement of performance for each recovery action is applied to train the neural network, and
wherein the framework is programmed provide a trained GCN-integrated reinforcement learning model that is programmed to generate recovery output data representing a sequence of recovery actions for the UDN in response to input UDN state data representative of a current state of the UDN.

2. The system of claim 1, wherein the performance calculator is further programmed to determine the measure of performance of the UDN responsive to each of a plurality of respective recovery actions for a respective episode of recovery actions based on the current state-space and a next-state space for the UDN.

3. The system of claim 1, wherein the UDN is a water distribution network and the GCN is configured to encode structural information for the water distribution network.

4. The system of claim 1, wherein the GCN is programmed to provide the GCN output as a matrix representing at least one state space value for respective parameters of each node of the UDN model, the framework is further programmed to convert the matrix into a corresponding vector that is received by the first layer of the neural network.

5. The system of claim 1, wherein the GCN output data is provided by aggregating an output for each node dimension of the GCN.

6. The system of claim 1, wherein the reinforcement learning framework is further programmed to at least:
perform an analysis of distribution of a commodity through the UDN based on simulation for a sequence of recovery actions for one or more components of the UDN, wherein the sequence of recovery actions defines a respective episode, wherein the performance calculator is programmed to compute the measurement of the performance as a deep Q function, which has a Q value based on an instant reward component and a future reward component, the Q value being used to train the neural network,
wherein the training is repeated over a number of episodes, in which the state space parameters for the UDN are updated for each of the episodes.

7. The system of claim 6, wherein the performance calculator is further programmed to feed the updated state of UDN into a deep Q function, which includes the GCN and the neural network, and the deep Q functions provides the future reward component as a maximum future reward based on the updated state of the UDN.

8. A computer-implemented method to facilitate recovery decisions for a water distribution network (WDN), comprising:
storing, in one or more non-transitory machine-readable media, WDN model data representative of the WDN and having a plurality of nodes and parameter data characterizing features associated with respective nodes of the WDN;
using a graph convolutional neural network (GCN) to encode the structure of the WDN and the parameter data, provide GCN output data responsive to an input representative of at least a current state of the WDN;
receiving by a neural network the GCN output;
providing, by the neural network, a sequence of recovery actions based on a current state space of the WDN model data and a measure of performance;
computing the measure of performance of the WDN in response to each of a plurality of recovery actions applied to the WDN model data based on the WDN model data for a current state space and over time;
applying the measurement of performance for each recovery action to train the neural network,
repeating the training to provide a trained GCN-integrated reinforcement learning model, in which the trained GCN-integrated reinforcement learning model is programmed to generate output data representing a sequence of recovery actions for the WDN in response to input WDN state data representative of a current state of the WDN.

9. The method of claim 8, wherein
the input representative of at least the current state of the WDN includes graph structure data representative of the WDN structure, features for each node, and node satisfactory degree representative of system performance for the WDN, and
the GCN output data is a matrix of vectors representative of the current WDN, in which each node dimension of the matrix is aggregated to provide the GCN output as a one-dimensional vector space.

10. The method of claim 8, wherein the GCN is trained by a deep reinforcement learning framework programmed to perform a method comprising:
performing an analysis of hydraulic distribution through the WDN based on simulation for a sequence of recovery actions for one or more components of the WDN, wherein the sequence of recovery actions defines a respective episode and the measure of performance represents a Q determined by a Q function based on an instant reward component and a future reward component, the Q value being used to train the neural network,
wherein the training is repeated over a number of episodes, in which the state space parameters for the WDN are updated for respective actions implemented in each of the episodes.
